(19) United States
(12) Patent Application Publication
(10) Pub. No.: US 2005/0257571 A1
(43) Pub. Date: Nov. 24, 2005

(54) Method and apparatus for manufacturing a glass preform

(75) Inventors: Hisashi Koaizawa, Tokyo (JP); Toshihiro Nakamura, Tokyo (JP); Akinari Uchikoshi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: The Furukawa Electric Co, Ltd., Tokyo (JP)

(21) Appl. No.: 10/847,397

(22) Filed: May 18, 2004

(51) Int. Cl. C03B 37/018

(52) U.S. Cl. 65/397; 65/426; 65/422; 65/399; 65/529; 65/530; 65/374.13

(57) ABSTRACT

A method for manufacturing a glass preform, which contains the step of: heat treating a soot preform in a muffle tube, wherein the muffle tube is made of silicon carbide, and a density of the silicon carbide is 3.0 g/cm³ or more; and an apparatus for heat treating usable in the method.

### FIELD

The present invention relates to a method for manufacturing a glass preform. Further, the present invention relates to an apparatus for manufacturing a glass preform.

### BACKGROUND

Conventionally, a quartz muffle tube is used in a heating furnace used for dehydrating and sintering a soot preform manufactured by a VAD (vapor-phase axial deposition) method or OVD (outside vapor deposition) method. Although the quartz muffle tube is an excellent muffle tube which does not generate impurities such as metal even under a high temperature, the quartz muffle tube is softened under a high temperature, which is a disadvantage. Thus, when heat treating a soot preform, a differential pressure between the inside and the outside of the muffle tube must fall within a predetermined range. As a result, the facility becomes complex.

Further, if the temperature is raised to 1200° C. or more and then dropped to 300° C. or lower, the quartz muffle tube is devitrified and cracked. Thus, the quartz muffle tube must be always kept at a high temperature, which leads to a problem that the energy is wasted.

To solve the above mentioned problem, there have been proposed, for example, a method in which a carbon coating or silicon carbide coating is coated onto a carbon muffle tube, or a method in which a carbon coating or silicon carbide coating is coated onto a high purity silicon carbide muffle tube. However, these methods have the following problems.

In a case of using a carbon muffle tube coated with a carbon coating;

Moisture or gases, such as oxygen, hydrogen, and the like (including the ones adsorbed or chemically reacted), which are contained in a soot preform, react with the carbon of the muffle tube during a heat treatment, to thus consume the muffle tube. The carbon particles on the surface of the muffle tube are dropped out and adhered to the soot perform, as the consumption of the muffle tube proceeds.

In a case of using a carbon muffle tube coated with a silicon carbide coating;
A dehydrating gas (generally, chlorine is used) reacts with moisture or oxygen/hydrogen at a high temperature to generate a HCl gas, the resulting gas leads to corrosion of the silicon carbide to expose the carbon surface, and the moisture in the soot causes a rapid oxidation to consume the muffle tube. Further, a reactive gas permeates and flows out of the muffle tube due to the permeability of carbon, thereby leading to corrosion of the furnace body surrounding the muffle tube. Furthermore, because of a gap between silicon carbide and carbon in thermal expansive coefficient, a rapid raising and dropping of temperature is impossible.

In a case of using a high-purity silicon carbide muffle tube coated with a carbon coating or a silicon carbide coating;
The high purity silicon carbide generally has a low density of 2.4 to 2.8 g/cm³ and is porous with a porosity of 15 to 25%, thus the reactive gas permeates and flows out of the muffle tube to corrode the furnace body surrounding the muffle tube. Furthermore, since the surface area is large because the muffle tube surface is uneven and convexoconcave, the coating particles of the surface are dropped out by a dehydrating gas or doping gas, and adhered to the soot preform.

There is a method, in which a dehydrating process using a large quantity of a dehydrating gas (at 800 to 1200° C.) is carried out in a heating furnace using a quartz muffle tube, and fluorine doping and sintering are carried out in the above mentioned muffle tube. However, the method has such a problem that a number of equipment units is increased since two type heating furnaces are required.

### SUMMARY

The present invention resides in a method for manufacturing a glass preform, which comprises the step of:
heat treating a soot preform in a muffle tube, wherein the muffle tube is made of silicon carbide, and a density of said silicon carbide is 3.0 g/cm³ or more.

Further, the present invention resides in an apparatus for manufacturing a glass preform, which comprises:
a muffle tube for heat treating a soot preform therein,
   wherein the muffle tube is made of silicon carbide, and a density of said silicon carbide is 3.0 g/cm³ or more.

Other and further features and advantages of the invention will appear more fully from the following description, taken in connection with the accompanying drawings.

### BRIEF DESCRIPTION OF THE DRAWINGS

FIG. 1 is a cross sectional view schematically showing an embodiment of the heat-treating apparatus of the present invention which is an apparatus for manufacturing a glass preform;

FIG. 2(a) is a sectional view of a part of a silicon carbide muffle tube; and FIG. 2(b) is a partially-enlarged sectional view of FIG. 2(a);

FIG. 3 is a graph showing a refractive index profile of a dispersion-compensating fiber (DCF) manufactured in Example 3 stated below;

FIG. 4 is a sectional view schematically showing another embodiment of the heat-treating apparatus of the present invention which is an apparatus for manufacturing a glass preform; and

FIG. 5 is a sectional view schematically showing still another embodiment of the heat-treating apparatus of the present invention which is an apparatus for manufacturing a glass preform

### DETAILED DESCRIPTION

The present inventors have studied keenly and found the following. That is, an increased density of silicon carbide used as a muffle tube decreases fine convex and concave portions on the surface of the muffle tube, to thereby reduce consumption of the muffle tube even if the muffle tube is exposed to a chlorine- or fluorine-series gas. Further, by using a high-density silicon carbide to form a muffle tube, and further by carrying out a more dense silicon carbide coating, even if the muffle tube is consumed, the inside and outside of the muffle tube can be air-tightly separated, which completely avoids corrosion of the furnace body surrounding the muffle tube. Further, the silicon carbide muffle tube is strong to a heat shock, and is not damaged even when it is heated to 1600° C. or higher and then cooled with the power turned off. Further, the temperature of the apparatus can be increased rapidly from a low temperature level.

That is to say, in the heat treating apparatus of the present invention, the muffle tube is hardly consumed even with such a rapid temperature change, particularly, the life span of the muffle tube is not reduced even with a rapid temperature raising and dropping. Accordingly, during this apparatus is not used, the power can be turned off by which the energy can be saved. In a case that the apparatus needs no operation or in a case that the kind of dopant is changed, the muffle tube can be replaced with a new one by dropping the temperature. Further, it is possible to cope with a wide variety of dopants without damaging the muffle tube, thereby reducing the cost.

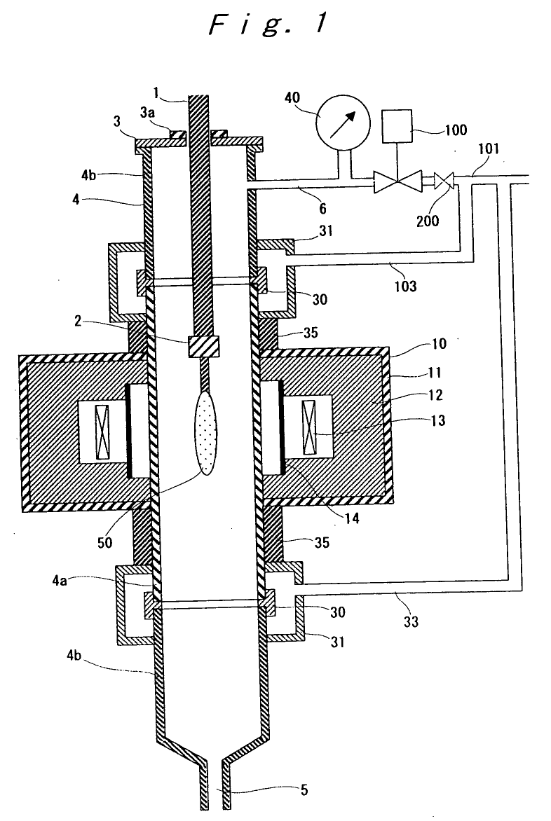

Hereinafter, some preferred embodiments of the heat-treating apparatus of the present invention will be described in detail, referring to FIGS. 1 to 5. Herein, the same components or members in the respective figures are illustrated with the same numerals and names.

FIG. 1 is a cross sectional view schematically showing an embodiment of the heat-treating apparatus of the present invention which is an apparatus for manufacturing a glass preform.

In the central portion of the apparatus for manufacturing a glass preform, as shown in FIG. 1, a muffle tube 4 into which a soot preform 50 is inserted is placed. A heat treatment furnace 10 including a carbon heater 13 and a furnace body 11 surrounding the carbon heater 13 is placed on the circumference of the muffle tube 4. A gas vent 6 is formed above the muffle tube 4, and a gas feeding inlet 5 is formed below the muffle tube 4. A predetermined amount of gas flows from the bottom of the muffle tube 4 to the upper part of the muffle tube 4 via the gas vent 6 from the gas feeding inlet 5. Further, an upper cover 3 is placed on a top of the muffle tube 4, and a rotatable and vertically-movable lifting axis 1 is penetrated through the upper cover 3. At the tip of the lifting axis 1, a preform holding portion 2 for retaining the soot preform 50 is formed.

The soot preform 50 is inserted from the upper part of the muffle tube 4 via the preform holding portion 2 placed on the lifting axis 1, and heat treatment including dehydration, doping, sintering, and the like, is carried out at the highest temperature portion of the muffle tube 4 around the heater 13.

In order to prevent air from flowing in through a gap between the upper cover 3 and the lifting axis 1, a seal ring 3a is placed on the upper cover 3. A motor valve 100 and a differential pressure gauge 40 are mounted on the gas vent 6, the vent being connected to an exhaust line 101. A damper 200 is placed at the back of the motor valve 100 and is used for roughly adjusting the pressure in the muffle tube 4.

Within the heat treatment furnace 10, a soaking tube 14 is placed between the heater 13 and the muffle tube 4. The heater 13 is covered with a heat insulating material 12 and is further surrounded by the furnace body 11. At upper and lower parts of the heat treatment furnace 10, another heat insulating material 35 is placed along the muffle tube 4. In the case of using a carbon heater 13, the soaking tube 14 is made of carbon. The heat insulating material 12 is also made of a molded form of carbon fiber. These carbons to be used are processed to have a high purity.

In FIG. 1, in the muffle tube 4, a silicon carbide muffle tube 4a is employed only at a high temperature portion around the heater 13, and quartz muffle tubes 4b are connected to the upper and lower parts of the muffle tube 4a. The reasons of which are the processibility of quartz is good, it has no risk that the quartz muffle tubes are devitrified since the upper and lower parts become 1000° C. or less, and, furthermore, a heat loss can be made smaller since the heat conduction of quartz is smaller than that of silicon carbide.

The silicon carbide muffle tube 4a and the quartz muffle tube 4b are connected by an adaptor 30, and the adaptor 30 is covered by an exhaust cover 31. To the exhaust cover 31, a local exhaust pipe 33 and a muffle tube purge line 103 are connected, which are also connected to the exhaust line 101, respectively.

The muffle tube 4a is prepared as follows. Particles of silicon carbide that are a raw material, and a sintering aid are mixed, put into a mold, pressure-formed, and then sintered in a high temperature furnace under an atmospheric (normal) pressure i.e. 0.1 MPa, thereby obtaining a muffle tube with a given shape. If necessary, the muffle tube is processed and finished in shape.

The silicon carbide that can be used in the present invention is sintered under an atmospheric pressure, thus it can become fairly dense.

As described above, although the high density silicon carbide for use in the present invention is made by an atmospheric sintering process, the silicon carbide is degraded in purity since it contains several percents (%) of free silicone or carbon during production. The purity can be improved by oxidizing the silicon carbide at an initial stage, or by raising the temperature of the silicon carbide to more than a processing temperature and baking the same, or by exposing the silicon carbide to a halogen gas atmosphere at a high temperature. Further, in case of sintering the silicon carbide, boron or the like can be used as a sintering aid, and this causes the degradation of the purity of the glass preform to which a heat treatment is to be carried out. However, as a result of actually dehydrating and sintering a soot preform, boron or the like detected from a produced glass is no more than a level of ppb range.

The density of the silicon carbide that can be used in the muffle tube in the present invention is preferably 3.0 to 3.2 g/cm³, more preferably 3.14 to 3.18 g/cm³. By using the silicon carbide with a high density of 3.0 g/cm³ or more, the inside and outside of the muffle tube can be air-tightly separated even if the muffle tube is consumed, and corrosion of the furnace body surrounding the muffle tube can be prevented. Further, by increasing the density of the silicon carbide, fine convex and concave portions on the surface of the muffle tube can be reduced, to thereby make the surface area smaller than that of the conventional high-purity silicon carbide muffle tube, and, accordingly, reduce consumption of the muffle tube even if it is exposed to a chlorine- or fluorine-series gas.

To aim at a high purity of the silicon carbide muffle tube and prolong the life of the muffle tube, a silicon carbide coating can be coated onto the surface of the muffle tube. As described above, when the density of the silicon carbide used as the muffle tube is increased, the surface of the muffle tube becomes dense to reduce the surface roughness. By this, pin holes can be substantially reduced in the silicon carbide coating itself, and since thermal expansion coefficients of silicon carbide of both the muffle tube and the coating are almost the same, the stress remaining on the silicon carbide coating layer is reduced. As a result, even if a sharp temperature change like a rapid temperature raising is made, it is hard to peel off the silicon carbide coating, thus making it possible to extend the life of the muffle tube. That is, the life of the muffle tube can be kept long, even if the time period for raising or dropping a temperature of the heat treatment apparatus of the present invention is made shorter than that of the conventional apparatus.

In the present invention, the density of the silicon carbide that can be used for the coating is generally 3.0 to 3.2 g/cm³, preferably 3.14 to 3.18 g/cm³, and preferably close to the density of the silicon carbide used for the muffle tube. The silicon carbide coating has generally a thickness ranging from 10 to 200 μm, preferably 20 to 100 μm. The silicon carbide coating is carried out generally at a temperature of 1400° C. or higher, preferably 1600° C. or higher.

Further, a silicon carbide, which is made by impregnating a conventional high-purity and low-density silicon carbide with silicon and then applying the silicon carbide coating on the silicon carbide impregnated, can be used. The density of the above-mentioned silicon-impregnated silicon carbide is generally from about 3.0 to 3.1 g/cm³. This material can be used only with a temperature ranging from the melting point of silicon to a lower temperature, i.e. approximately 1400° C. or lower. However, since the silicon-impregnated silicon carbide has a high purity, it is preferable for manufacturing an optical fiber preform which results an optical fiber for use at a relatively long distance.

A quartz muffle tube is softened at 1200° C. or higher, so it needs a control for making the pressure in the muffle tube higher by several tens of Pa than the pressure in the furnace body, contrary to the above the present invention does not need such a control. However, this control of making the pressure in the muffle tube higher than an atmospheric pressure is preferable, in view of preventing air from being involved or sucked into the muffle tube.

Next, the method of the present invention for manufacturing a glass preform is described, but the present invention is not limited thereto.

In the method for manufacturing a glass preform according to the present invention, a muffle tube is preferably heated at 800 to 1600° C. under an inert gas atmosphere, an oxygen-containing atmosphere or a halogen gas atmosphere, before a soot preform is put into the muffle tube of the apparatus of the present invention for manufacturing a glass preform. By this, a free carbon or silicon contained in the silicon carbide can be removed in a gaseous phase by oxidization, or can be removed by vaporization at a high temperature or by reacting with halogen. Further, it is also possible to remove the particles adhered to the silicon carbide muffle tube after heat treatment or upon putting in or taking out the preform, thus the soot preform can be processed always under a clean atmosphere.

Further, in the method for manufacturing a glass preform according to the present invention, at least one step of the heat treatment is preferably conducted, under an atmosphere containing at least one gas selected from a silicon-containing fluoride gas, a carbon-containing fluoride gas, a silicon-containing chloride gas, a carbon-containing chloride gas, or a chlorine gas.

In case of using a halogen-series gas, such as chlorine, fluorine, and the like, in consideration of the equilibrium theory, when the treatment is carried out under a silicon- or carbon-containing gas atmosphere, the reaction amount of a halogen gas and a silicon carbide used in the muffle tube becomes smaller. Specifically, in case of dehydrating with a chlorine-series gas, the life of the silicon carbide can be extended by the use of SiCl₄, CCl₄, or a mixed gas thereof. Further, since the dehydration efficiency is better when only chlorine is used, a dehydrate treatment can be carried out within a shorter period of time when the above mixed gas further mixed with chlorine is used.

Likewise, in case of fluorine doping, the consumption of a silicon carbide or a silicon carbide coating can be reduced by the use of a silicon fluoride, such as SiF₄, Si₂F₆ or Si₃F₈, carbon fluorides, such as CF₄, C₂F₆, or C₃F₈, or a mixed gas thereof.

In the heat treating method of the present invention, it is preferred that a soot preform is doped with at least one of boron and aluminum, or that it is further doped with another dopant (phosphorus or the like).

With the soot preform doped with any of these, a heat treatment temperature can be set to a lower level.

The present invention will be described in more detail based on the following examples, referring as an example the method for manufacturing an optical fiber preform, but the invention is not meant to be limited by these examples.

### EXAMPLES

### Example 1

A glass preform for an EDF (erbium doped fiber) was produced, by using the heat treating apparatus, as shown in FIG. 1. The density of silicon carbide used for the muffle tube was 3.15 g/cm³. First, a core soot preform with an about 300 mm length, made by doping silica glass with Ge and Al, was prepared by the VAD method, and erbium chloride was added thereto by a solution impregnation method, and then dried, to thus produce a core soot preform. The thus-obtained core soot preform was dehydrated and sintered by the heat treating apparatus, as shown in FIG. 1, to thus obtain a glass core rod. The processing conditions are as follows.

Dehydration Step

Temperature: 1100° C.
Atmosphere gas: a mixed gas of He and chlorine (chlorine concentration: 3 vol %)
   Sintering Step
Temperature: 1500° C.
Atmosphere gas: He

Although this treatment was carried out repeatedly 10 times, the reduction of the mass of the muffle tube was less than 1%. Here, the initial mass of the muffle tube was the mass measured after baking it in the air.

Further, a soot formable into a cladding was deposited on the outer circumference of this core rod by the OVD method, and then dehydrated and sintered by using the heat treating apparatus of the present invention, to thereby obtain an optical fiber preform. The thus-obtained glass preform was drawn, and a 50-km optical fiber was obtained. And then the obtained optical fiber was subjected to 1% screening. It was not broken or disconnected by the screening. Further, as a result of measuring a transmission loss of the obtained optical fiber, the background loss at a wavelength 1200 nm was 2 dB/km or less, which was the loss of the level same as an optical fiber made by using an optical fiber preform that is produced by the use of a conventional quartz muffle tube.

### Example 2

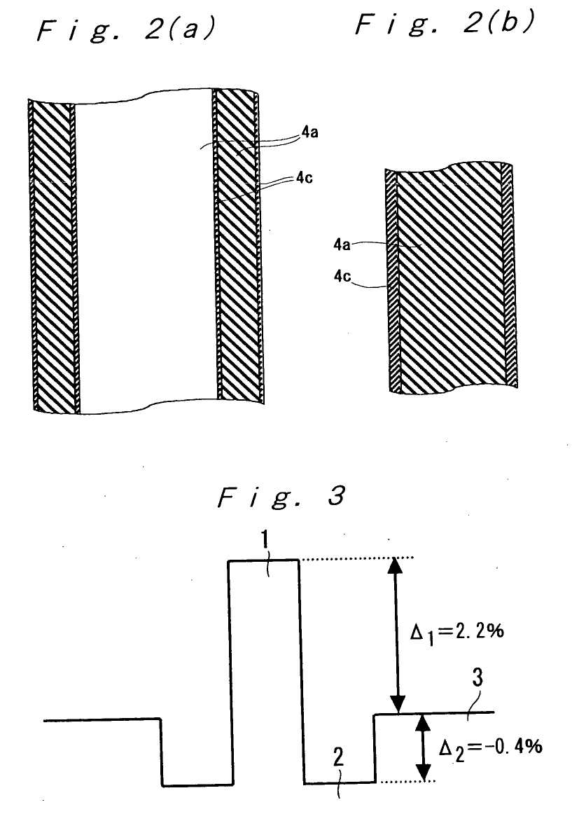

A muffle tube was made from an atmospherically sintered silicon carbide of 3.0 to 3.18 g/cm³ density, and the silicon carbide coating was coated on the entire surfaces of the muffle tube made as described above at a thickness of 20 to 200 μm. The following test was performed by using this muffle tube. Here, FIGS. 2(a) and 2(b) show sectional views of the silicon carbide muffle tube utilized in this example. FIG. 2(a) is a sectional view of the silicon carbide muffle tube, and FIG. 2(b) is an enlarged sectional view thereof. In this example, the silicon carbide coating layer 4c was formed on the surface of the muffle tube 4a made of the silicon carbide.

The core soot preform synthesized by the VAD method, underwent a dehydration step, a fluorine doping step, and a sintering step, successively in this order, to thus obtain a glass core rod. The thus-obtained core rod was stretched and used as a starting rod, and soot was deposited on the outer circumference thereof. The obtained soot preform with an about 1000 mm length was doped with fluorine by using the heat treating apparatus of the present invention. The processing conditions are as follows.

Dehydration Step

Temperature: 1000° C.
Atmosphere gas: a mixed gas of He and chlorine (chlorine concentration: 1 vol %)
Preform falling speed: 200 mm/hr
   Fluorine Doping Step
Temperature: 1300° C.
Atmosphere gas: a mixed gas of SiF₄ and He (SiF₄ concentration: 13 vol %)
Preform falling speed: 150 mm/hr
   Sintering Step
Temperature: 1400° C.
Atmosphere gas: He
Preform falling speed: 200 mm/hr

As a result of repeating the above steps of process 10 times, the reduction of the mass of the muffle tube was 1% or less. The thickness of the muffle tube was 7 mm at an initial stage. After the processing, no change was observed within the accuracy of measurement. Further, there was a rapid increase in temperature up to about 1600° C. in one hour, however no crack was observed but slight discoloration or change by adherent substances was observed with the naked eye. Further, this rapid temperature increase was repeated for several months, but no crack was occurred in the silicon carbide coating.

### Comparative Example 1

A muffle tube was made from carbon, and silicon carbide was coated on the entire surfaces of the muffle tube. The test was performed in the same manner as in Example 2, except for using the thus-obtained muffle tube. As a result of repeating the above steps of process 10 times, the reduction of the mass of the muffle tube was 5% or more. Further, after repeating the above-mentioned rapid temperature increase for several months, cracks were occurred in the silicon carbide coating.

### Comparative Example 2

The test was performed in the same manner as in Example 2, except that a high-purity silicon carbide substrate (density: 2.5 g/cm³) was used to form a muffle tube. As a result of repeating the above steps of process 10 times, the reduction of the mass of the muffle tube was 5% or more. Further, after repeating the above-mentioned rapid temperature increase for one month, cracks were occurred in the coating. The reason of this is presumed that the surface of the silicon carbide substrate was uneven to have convex and concave thereon. Further, it was difficult to perform coating per se so that no pin hole would be caused.

### Example 3

By using the apparatus of Example 2, a glass preform for a DCF (dispersion-compensating fiber) was prepared. As shown in FIG. 3, a typical refractive index profile of the DCF includes a first core 1 located at the center and having a high refractive index, a second core 2 surrounding the first core 1 and having a lower refractive index than that of the first core 1, and a cladding 3 surrounding the second core 2 and having a refractive index lower than the first core 1 but higher than the second core 2. The cladding is generally made of pure silica. In this example, the apparatus was used for manufacturing the second core 2. A soot preform prepared by the VAD method was dehydrated and sintered. The thus-obtained core glass rod having a relative refractive index difference Al of 2.2% was stretched, and used as a starting rod, and silica soot was deposited thereon. The soot was doped with fluorine by a sintering step, to thus manufacture the second core. Fluorine was doped so that the second core would have a relative refractive index difference Δ₂ of −0.4%. Besides, other portions were processed by a heat treating apparatus with a conventional quartz muffle tube, to thus manufacture a glass preform for a DCF.

Here, the specific refractive index differences Δ₁ and Δ₂ are defined by the following formula:
Δ₁={(n₁−n_{c})/n₁}×100 (1)
Δ₂={(n₂−n_{c})/n₂}×100 (2)
wherein, in each formulas, n₁ is the maximum refractive index of the first core, n₂ is the minimum refractive index of the second core, and nc is the refractive index of the cladding.

After the thus-obtained glass preform was drawn, it was subjected to 1% screening. As a result, the thus-drawn glass was of the same level as a glass made by using a glass preform that is produced by using a conventional quartz muffle tube, which showed no problem. Further, the transmission loss was of the same level, too. In the muffle tube used in this example, even after a rapid temperature increase was repeated for several months, no crack was observed on the silicon carbide coating with the naked eye. Moreover, even after temperature raising and dropping were repeated each week, no crack was observed on the silicon carbide coating with the naked eye.

### Comparative Example 3

A second core portion of a DCF was made in the same manner as in Example 3, except that the muffle tube made of quartz was used. As a result of raising the temperature and maintaining it for one month and then lowering the temperature, the quartz muffle tube was made unusable because cracks were occurred in the muffle tube.

### Example 4

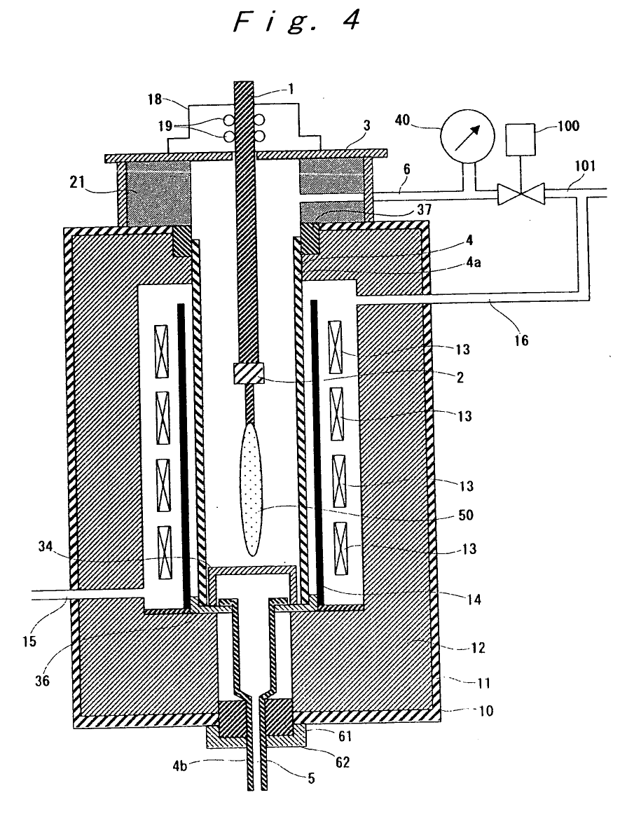

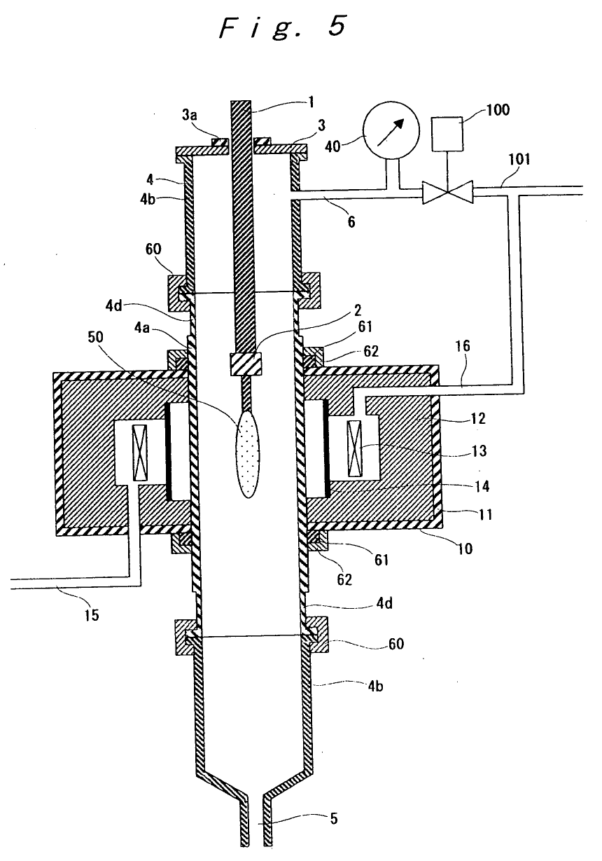

The heat treating apparatus, as shown in FIG. 4, was used. FIG. 4 is a sectional view schematically showing another embodiment of the apparatus of the present invention for manufacturing a glass preform. As shown in FIG. 4, in the apparatus, a plurality of the heaters 13 are mounted on the furnace body 11, each of the heaters 13 capable of controlling temperature independently. The soot preform 50 is fixed in a position, and thus made only rotatable. By controlling the temperature of each heater, a heat treatment can be carried out by changing a temperature distribution at a constant speed in the longitudinal direction of the preform, or by heating the preform 50 in a lump at nearly a uniform temperature over the entire length. Further, the entire muffle tube 4 is surrounded by the heat treatment furnace 10, the furnace body 11 is provided with a furnace body gas feed inlet 15 and a furnace body gas vent 16, thus a heat treatment can be carried out even under a pressurized atmosphere or a reduced-pressure atmosphere. The muffle tube 4 is supported on a muffle tube holder 36, and a gas rectifier plate 34 is placed at a lower part in the muffle tube 4. By blocking the gap between the heat treatment furnace 10 and the muffle tube 4 by a sealing member 61, and covering with a furnace sealing portion 62 from the top thereof, gas leakage from the furnace body 11 can be prevented. The gap between the heat treatment furnace 10 and the muffle tube 4 is also blocked by a sealing member 37. The sealing member 37 is manufactured from a carbon felt or an alumina blanket. A heat insulating material 21 is placed in the upper cover 3. Further, an axial sealing cover 18 is placed on an upper part of the upper cover 3, and an axial sealing O-ring 19 is fit into the axial sealing cover 18.

A soot preform for a standard single mode fiber with a cladding/core ratio of 4.3 prepared by the VAD method, was dehydrated and sintered by a heat treating apparatus with a quartz muffle tube, to thus obtain a core glass rod. The core glass rod was stretched and used as a starting rod, and silica soot was deposited on the outer circumference of the rod by the OVD method. The thus-obtained soot preform with an about 800 mm length was dehydrated and sintered by using the apparatus, as shown in FIG. 4. The processing conditions are as follows. The heat treatment was carried out with the position of the soot fixed.

Dehydration Step

Temperature: 1250° C.
Atmosphere gas: a mixed gas of He, chlorine and SiCl₄
   (He:Chlorine:SiCl₄=100:2:1(vol %))
Soaking time: 3 hours
   Sintering Step
Temperature: the maximum temperature 1480° C.
Atmosphere gas: He
Heat zone moving speed: 250 mm/hr

After the above steps of process was repeatedly carried out 10 times, the reduction of the mass of the silicon carbide muffle tube coated with the silicon carbide coating was 1% or less. Here, as the silicon carbide coating, the one treated within a range of 1500 to 1600° C. which was higher than the treating temperature, was used. The life of the muffle tube was longer, as compared with the apparatus having the coating treated at 1400° C.

As a result of drawing the thus-obtained optical fiber perform, an optical fiber was obtained. And 1% screening was carried out to the obtained optical fiber. Consequently, the obtained optical fiber was of the same level as an optical fiber formed with an optical fiber preform made by using a quartz muffle tube.

### Example 5

The heat treatment apparatus, as shown in FIG. 5, was used. FIG. 5 is a sectional view schematically showing another embodiment of the apparatus of the present invention for manufacturing a glass preform. As shown in FIG. 5, flanges 60 are attached to both opposite ends of the silicon carbide muffle tube 4a, and the silicon carbide muffle tube 4a is air-tightly connectable to quartz muffle tubes 4b at upper and lower parts thereof by the flanges 60. By this structure, it is possible to prevent a halogen-series gas fed into the muffle tube 4 from leaking at a portion where the silicon carbide muffle tube 4a and the quartz muffle tube 4b are jointed. Further, the silicon carbide muffle tube 4a in both opposite ends 4d each are processed to have a small thickness, which makes it difficult to transfer the heat received from the heater 13 to the flanges 60.

A soot preform of an about 600 mm length synthesized by the VAD method, underwent, by using the heat treating apparatus of FIG. 5, a dehydration step, a fluorine doping step, and a sintering step, successively in this order, to thus obtain a glass rod doped with fluorine. As the result of measuring the refractive index of the obtained glass rod, a relative refractive index difference Δ₃ with pure silica was −0.7%. The processing conditions are as follows.

Here, the relative refractive index difference Δ₃ is defined by the following formula:
Δ₃={n₃−nₛ}/n₃}×100 (3)
wherein n₃ is the minimum refractive index of the obtained glass rod, and ns is the refractive index of pure silica.
   Dehydration Step
Temperature: 1150° C.
Atmosphere gas: a mixed gas of He, chlorine, SiC₄ and CCl₄
   (He:Chlorine:SiCl₄:CCl₄=10:2:0.5:0.5 (vol %))
Preform falling speed: 180 mm/hr
   Fluorine Doping Step
Temperature: 1280° C.
Atmosphere gas: a mixed gas of SiF₄ and CF₄ (SiF₄:CF_{4=2:1} (vol %))
Preform falling speed: 200 mm/hr
   Sintering Step
Temperature: 1300° C.
Atmosphere gas: He
Preform falling speed: 200 mm/hr

As a result of mixing chlorine with the mixed gas of SiCl₄ and CCl₄, the dehydration treatment took a longer time than in the case when treated with chlorine only. On the other hand, as for the fluorine doping treatment, as a result of using a mixed gas of SiF₄ and CF₄, the consumption of the silicon carbide coating or silicon carbide of the muffle tube was reduced, as compared to the case when treated with chlorine only.

The heat treating method and apparatus of the present invention can be used not only for the manufacture of an optical fiber preform explained in detail in the above EXAMPLES section but also for the heat treatment of glass performs in general. For example, by utilizing the method or apparatus of the present invention, heat treatment can be carried out to the glass preform used for manufacturing a silica mask material for a semiconductor, or a glass tube or a glass fiber.

As concrete examples, the followings are included. The glass preform manufactured by the heat treating apparatus or heat treating method of the present invention is used as it is, or it is machine finished and thinned by a wire saw, and then a given surface thereof is subjected to lapping/polishing, thereby a photomask can be obtained. Further, the preform is stretched or drawn, thereby a quartz tube or fiber that can be used in chemical synthesis can be obtained. Further, these glass tubes or glass fibers are bundled, to thus make it possible to manufacture a filter made of glass. Further, it is possible to utilize these, for example, for a micro tube that can be used in a micro reactor, or for a capillary tube for electrophoresis for use in biology or biotechnology.

Having described our invention as related to the present embodiments, it is our intention that the invention not be limited by any of the details of the description, unless otherwise specified, but rather be construed broadly within its spirit and scope as set out in the accompanying claims.

1. A method for manufacturing a glass preform, comprising the step of:
heat treating a soot preform in a muffle tube, wherein the muffle tube is made of silicon carbide, and a density of said silicon carbide is 3.0 g/cm³ or more.

2. The method according to claim 1, wherein the silicon carbide is silicon carbide that is sintered under normal pressure.

3. The method according to claim 1, wherein the muffle tube has a silicon carbide coating on a surface thereof.

4. The method according to claim 3, wherein the silicon carbide coating is coated at a temperature of 1400° C. or higher.

5. The method according to claim 1, wherein the heat treating is a dehydration, doping or sintering process.

6. The method according to claim 1, wherein at least one step of the heat treating step is carried out under an atmosphere containing at least one gas selected from a group consisting of a silicon-containing fluoride gas, a carbon-containing fluoride gas, a silicon-containing chloride gas, a carbon-containing chloride gas, and a chlorine gas.

7. The method according to claim 1, wherein the method further comprises the step of:
heating the muffle tube at 800° C. to 1600° C. under an inert gas atmosphere, an oxygen-containing atmosphere or a halogen gas atmosphere, before putting the soot preform into the muffle tube.

8. The method according to claim 1, wherein the soot preform is doped with at least one selected from boron and aluminum.

9. An apparatus for manufacturing a glass preform, comprising:
a muffle tube for heat treating a soot preform therein,
wherein the muffle tube is made of silicon carbide, and a density of said silicon carbide is 3.0 g/cm³ or more.

10. The apparatus according to claim 9, wherein the silicon carbide is silicon carbide that is sintered under normal pressure.

11. The apparatus according to claim 9, wherein the muffle tube has a silicon carbide coating on a surface thereof.

12. The apparatus according to claim 11, wherein the silicon carbide coating is coated at a temperature of 1400° C. or higher.

13. The apparatus according to claim 9, wherein the heat treating is a dehydration, doping or sintering process.
